(19) United States
(12) Patent Application Publication
(10) Pub. No.: US 2026/0069964 A1
(43) Pub. Date: Mar. 12, 2026

(54) LOTTERY TICKET SELLING SYSTEMS CONFIGURED TO GENERATE CONDENSED PRINTED DRAW LOTTERY TICKETS

(71) Applicant: Brightstar Global Solutions Corporation, Providence, RI (US)

(72) Inventors: Paul Schneider, Jerome, ID (US); Gregory J. Spatuzzi, Cranston, RI (US)

(21) Appl. No.: 18/883,688

(22) Filed: Sep. 12, 2024

(51) Int. Cl. A63F 3/06; B41J 3/30; G06K 15/02; G07F 17/42

(52) U.S. Cl. CPC A63F 3/0655; B41J 3/30; G06K 15/024; G07F 17/42

(57) ABSTRACT

Lottery ticket selling systems and methods of operating the systems that enable the purchases of draw lottery tickets and includes the generation and printing of such purchased draw lottery tickets in a condensed draw lottery ticket layout.

### BACKGROUND

The present disclosure relates to lottery ticket selling systems configured to generate condensed printed draw lottery tickets.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket terminal including: a lottery ticket printer; a processor; and a memory device that stores a plurality of instructions, which when executed by the processor cause the processor to: receive lottery ticket information for a purchased draw lottery ticket; encode the lottery ticket information to generate draw lottery ticket encoded data for the purchased draw lottery ticket; generate human readable information based on the lottery ticket information; generate ticket printer data associated with a condensed ticket layout that comprises the draw lottery ticket encoded data and the human readable information; and cause the lottery ticket printer to print a physical printed lottery ticket in the condensed ticket layout for the purchased draw lottery ticket using the ticket printer data.

In various other embodiments, the present disclosure relates to a lottery ticket a lottery ticket terminal including: a lottery ticket printer; a processor; and a memory device that stores a plurality of instructions, which when executed by the processor cause the processor to: receive lottery ticket information for a purchased draw lottery ticket; determine a ticket layout for the purchased draw lottery ticket from among a plurality of different ticket layouts; responsive to the determined ticket layout being a condensed ticket layout: encode the lottery ticket information to generate draw lottery ticket encoded data for the purchased draw lottery ticket; generate human readable information based on the lottery ticket information; generate ticket printer data associated with a condensed ticket layout that comprises the draw lottery ticket encoded data and the human readable information; and cause the lottery ticket printer to print a physical printed lottery ticket in the condensed ticket layout for the purchased draw lottery ticket using the ticket printer data.

In various other embodiments, the present disclosure relates to a lottery ticket terminal including: a lottery ticket printer; a processor; and a memory device that stores a plurality of instructions, which when executed by the processor cause the processor to cause the lottery ticket printer to: print on paper each of a plurality of draw lottery tickets in a first layout; and print on paper each of the plurality of draw lottery tickets in a second condensed layout, wherein the second condensed layout is different than the first layout, wherein in the second condensed layout each printed draw lottery ticket is printed on a lesser amount of the paper than if printed in the first layout.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a lottery ticket selling system including a lottery terminal configured to print draw lottery tickets in a condensed ticket layout in accordance with one example embodiment of the present disclosure.

FIG. 3 is a diagrammatic view of the lottery terminal of FIG. 2 in accordance with the example embodiment of the present disclosure.

FIG. 4 is front view of an example draw lottery ticket in an example condensed ticket layout in accordance with one example embodiment of the present disclosure.

FIG. 5 is a flow diagram showing one example method of printing a draw lottery ticket in a condensed ticket layout using the lottery ticket selling system of FIG. 2 in accordance with one example embodiment of the present disclosure.

FIG. 6 is front view of a plurality of example draw lottery tickets in example condensed ticket layouts in accordance with an alternative embodiment of the present disclosure.

### DETAILED DESCRIPTION

In various embodiments, the present disclosure relates to lottery ticket selling systems and methods such as lottery terminals and methods of operating such lottery terminals. The lottery terminals enable the purchase of draw lottery tickets and generate and print such the purchased draw lottery tickets in a condensed ticket layout.

In various embodiments, the present disclosure relates to a lottery ticket selling system and method of operating the lottery ticket selling system, wherein the lottery ticket selling system includes: (a) a player electronic device; (b) a courier server; (c) a lottery terminal; and (d) a lottery ticket printer. The lottery ticket selling system enables the purchase of a draw lottery ticket by a user of the player electronic device and causes the generation and printing of the purchased draw lottery ticket in a condensed ticket layout.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

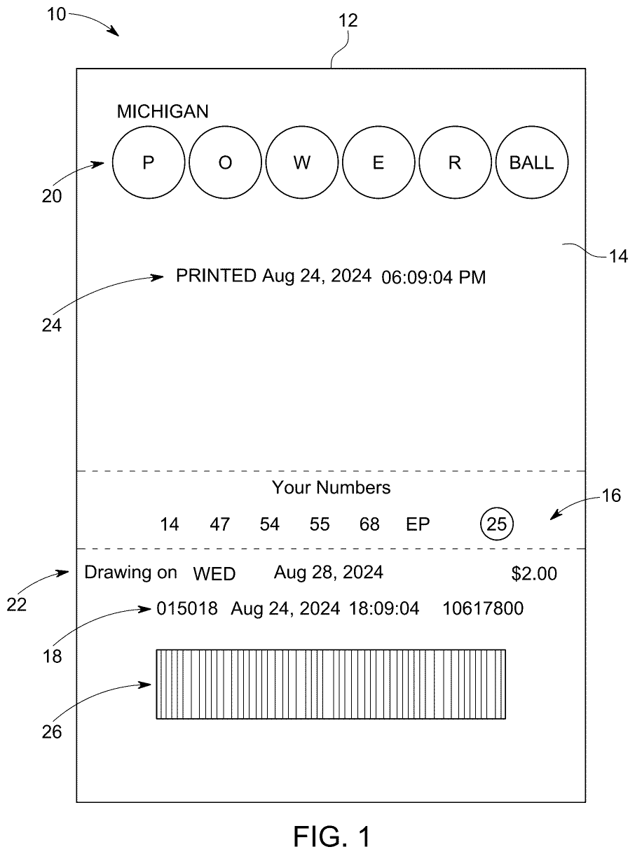

An example physical draw lottery ticket 10 is shown in FIG. 1. This example draw lottery ticket includes: (1) a ticket substrate 12; (2) a front surface 14 of the ticket substrate 12; (3) lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Wednesday Aug. 28, 2024) and includes a single set of player numbers 16 (i.e., player numbers for the single play of the draw lottery game). The lottery ticket information in this example includes player numbers 16, a ticket identifier 18 that uniquely identifies the lottery ticket 10, a game identifier 20 that identifies the lottery game type, a draw date 22 associated with the ticket 10, and a print date 24 on which the ticket 10 was printed. It should be appreciated that while this draw lottery ticket is for a single play, draw lottery tickets often include multiple sets of player numbers that are for a single play of the draw lottery game. The lottery ticket information can include text, one or more ticket numbers (shown as the ticket identifier 18), one or more ticket barcodes (shown as barcode 26), and other lottery ticket information that is in either or both human readable and machine readable forms. The lottery ticket's barcode 26 is configured to be scanned by a barcode reading device to enable redemption of such draw lottery ticket.

Additionally, for a better understanding of the present disclosure, various known systems and methods employed for purchasing draw lottery tickets are also now described.

In a first example known lottery ticket system and method for purchasing a draw lottery ticket for a draw lottery game in person, a player selects the player numbers for the draw lottery ticket and the player fills out a paper play slip with the player's selected numbers. The player hands that play slip to an operator of a lottery terminal and the operator causes the operator uses a lottery terminal including a contact image sensor (CIS) reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player. It should be appreciated that in certain such systems, the lottery terminal includes the CIS reader and the lottery ticket printer in one cabinet. In other systems, the CIS reader and/or the lottery ticket printer can be separate from the lottery terminal cabinet and connected to the lottery terminal by suitable wires.

In a slight variation of this first example known lottery ticket system and method for purchasing a draw lottery ticket for a draw lottery game in person, a player does not select the player numbers for the draw lottery ticket and the player marks a paper play slip with an indication of a requested quick pick for the player numbers. The player hands that play slip to an operator of a lottery terminal and the operator uses a lottery terminal including a CIS reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. In this case, the lottery terminal randomly generates the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a second example known lottery ticket system and method for purchasing a draw lottery ticket for a draw lottery game in person, a player does not fill out a paper play slip with the player's selected numbers, but rather the player tells the operator of a lottery terminal that the player wants to purchase a draw lottery ticket using a quick pick for a draw lottery game and the operator inputs that request into the lottery terminal (via an operator interface of the lottery terminal). The lottery terminal randomly determines the player numbers for the player's lottery ticket for the play of the lottery game and uses those numbers to create a draw lottery ticket. The lottery terminal then causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a third example known lottery ticket system and method for purchasing a draw lottery ticket for a draw lottery game in person, a player uses a suitable application on a player's computer such as a player mobile electronic device (such as a smartphone) to fill out an electronic play slip displayed by the player's computer with the player's selected numbers for the draw lottery game or a quick pick. The application creates a barcode displayable by the display device of the player mobile electronic device. The player causes their mobile electronic device to display the barcode such that a CIS reader of a lottery terminal having a barcode scanner scans the barcode and creates player slip scan data representing the player numbers or the quick pick for the play of the draw lottery game. The CIS reader sends the player slip scan data to a terminal application of the lottery terminal, and the terminal application uses that player slip scan data to create a draw lottery ticket including the player numbers (respectively either selected by the player or randomly selected by the lottery terminal). The lottery terminal causes a lottery ticket printer to print out the draw lottery ticket with the player numbers. The operator of the lottery terminal also collects the payment for the draw lottery ticket and provides the printed draw lottery ticket to the player.

In a fourth example known lottery ticket system and method for purchasing a draw lottery ticket for a draw lottery game remotely (from any lottery terminal), a player uses their computer such as a player mobile electronic device (such as a smartphone) to access a web site to fill out an electronic play slip with the player numbers (selected by the player or randomly selected by the web site) for the draw lottery game. The web site functions with a lottery host system to create a draw lottery ticket including the player numbers. The web site also functions with a lottery host system to obtain payment for the draw lottery ticket including the player numbers. The lottery host system creates a virtual draw lottery ticket with the player numbers for the player and sends that virtual draw lottery ticket to an email address of the player. This fourth example known system does not include any lottery terminal (or CIS reader thereof).

This fourth example known lottery ticket system is only legal in a limited quantity of jurisdictions (such as states in the United States) that permit the purchase of draw lottery tickets via such completely remote and electronic systems and methods.

In various other jurisdiction (such as states) that do not permit such completely remote and electronic purchase of draw lottery tickets (such as via the above described fourth example known system and method), a fifth example known lottery ticket system using a courier service has been employed. This fifth example known lottery ticket system and method has been used to enable players to remotely electronically purchase draw lottery tickets for draw lottery games wherein the courier service conducts various physical steps of the lottery ticket purchase process on behalf of the players. More specifically, in this fifth example known system and method for purchasing a draw lottery ticket for a draw lottery game remotely from any lottery terminal, a player uses a suitable application on their mobile electronic device (such as mobile telephone) to purchase a draw lottery ticket (which can include the player inputting the player's selected numbers or a quick pick indication for the draw lottery game). This application is often referred to as a courier mobile application. The courier mobile application functions to create lottery ticket purchase data (including the player's selected numbers or the quick pick numbers that the courier mobile application randomly selected) and causes the player's mobile electronic device to send the lottery ticket purchase data via a data network to a courier server at a courier processing center. The courier server uses the received lottery ticket purchase data to create and cause a courier printer to physically print a physical paper play slip for the play of the draw lottery game at the courier processing center. The play slip includes the player numbers. A human courier processing clerk takes the physical printed paper play slip for the play of the draw lottery game to an operator of a lottery terminal at a physical location of the lottery terminal that is remote from the courier processing center. The operator uses the lottery terminal (which includes a CIS reader) to scan the physical printed paper play slip. The CIS reader creates play slip scan data for the draw lottery ticket, and the terminal application of the lottery terminal uses that play slip scan data to determine the player numbers for the play of the draw lottery game and to create the lottery ticket (such as in the same manner as described above for the first example). The lottery terminal causes a lottery ticket printer to print out the draw lottery ticket with the player numbers. The operator of the lottery terminal also collects the payment for the draw lottery ticket from the courier processing clerk and provides the printed draw lottery ticket to the courier processing clerk. The courier processing clerk then takes the physical printed play slip and the physical printed draw lottery ticket back to the courier processing center. The courier processing clerk scans the physical printed lottery ticket using a courier scanning system connected to the courier server. The courier server links the scanned draw lottery ticket back to the player account established through the courier mobile application. The courier server then makes the scanned lottery ticket available for the player to view via the courier mobile application on the player's mobile electronic device. The courier processing clerk places the physical printed play slip and the physical printed lottery ticket in secure courier storage locations for storage if needed at a later time. After the draw for the play of the draw lottery game takes place, if the player's lottery ticket is a winning lottery ticket and the winning amount is less than $600, the courier server automatically credits the winning amount for the player's draw lottery ticket to the player's account. The courier service can then retrieve and redeem the stored actual winning physical printed lottery ticket at a location having a lottery terminal. After the draw for the draw lottery game takes place, if the player's lottery ticket is a winning lottery ticket and the winning amount is $600 or more, a courier processing clerk retrieves the stored winning physical player lottery ticket from the courier storage location and sends that physical printed lottery ticket to the player so that the player can cash in that lottery ticket and obtain the winning amount.

In various embodiments, such as further discussed below, the lottery ticket terminal, the lottery ticket selling systems, and methods of the present disclosure provide physical printed lottery tickets that reduce waste of physical supplies (such as paper and ink), transportation costs, and storage costs associated with the physical printed lottery tickets. Specifically, the physical printed lottery tickets have a condensed ticket layout, including draw lottery ticket encoded data, that reduces a physical size of the physical printed lottery ticket and quantities of the physical supplies needed to print the physical printed lottery tickets.

In various embodiments, a lottery terminal is configured to: (1) enable a user to select one or more different draw lottery tickets to purchase via user input device(s); (2) determine lottery ticket information for each purchased draw lottery ticket; (3) encode the lottery ticket information as draw lottery ticket encoded data; (4) generate ticket printer data with a condensed ticket layout that includes the draw lottery ticket encoded data and human readable information; and (5) cause a lottery ticket printer to print a physical printed lottery ticket in the condensed ticket layout.

In various embodiments, the lottery terminal is configured to: (1) enable a user to select one or more different draw lottery tickets to purchase via user input device(s); (2) determine lottery ticket information for each purchased draw lottery ticket; (3) store the lottery ticket information; (4) encode a link to the stored lottery ticket information as draw lottery ticket encoded data; (5) generate ticket printer data with a condensed ticket layout that includes the draw lottery ticket encoded data and human readable information; and (6) cause a lottery ticket printer to print a physical printed lottery ticket in the condensed ticket layout.

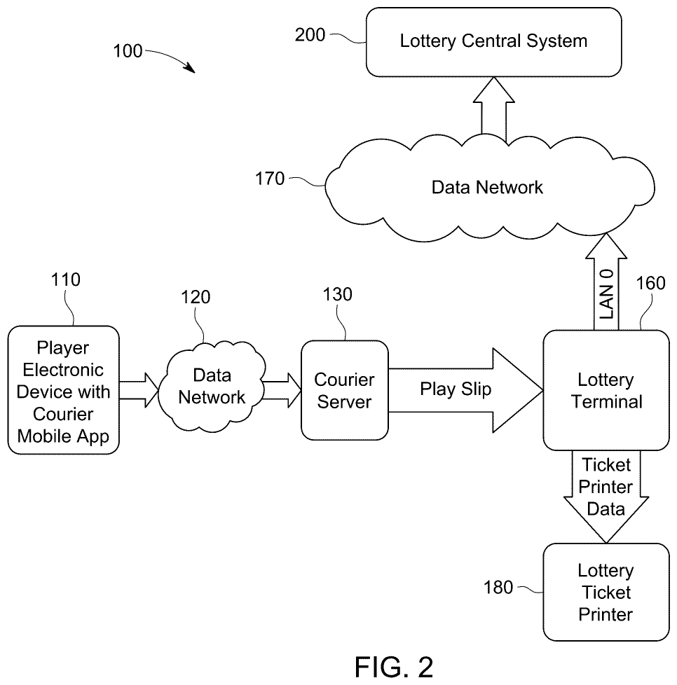

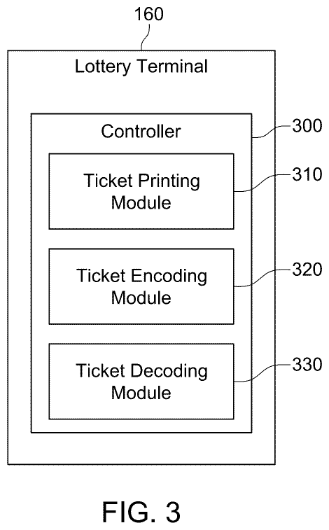

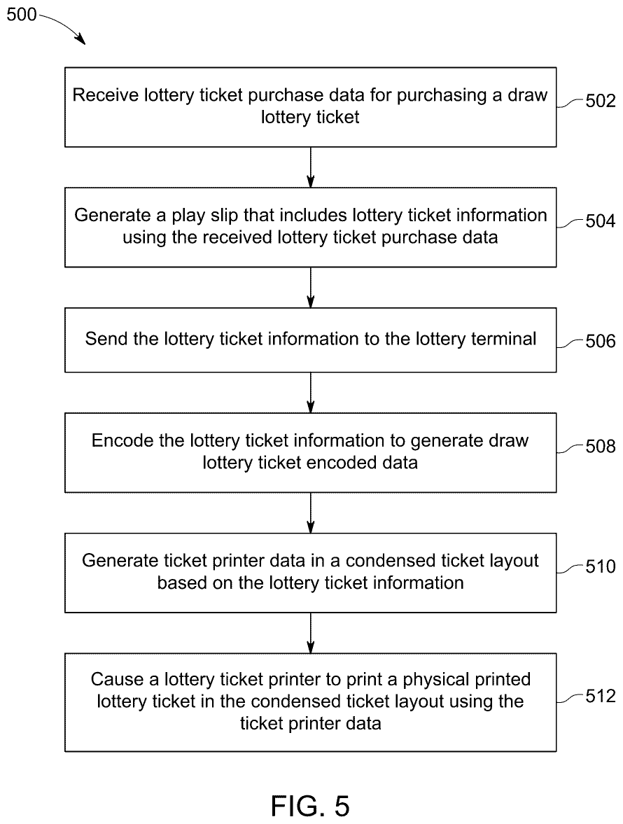

FIGS. 2 and 3 illustrate an example lottery ticket selling system 100 of one example embodiment of the present disclosure and FIG. 5 illustrates an example method 500 of operating the example lottery ticket selling system 100 in accordance with one example embodiment of the present disclosure. While this example explains various embodiments of the present in relation to a courier server (and related systems and methods), the present disclosure can be employed with other suitable servers, system, and methods that are not courier related.

This illustrated example embodiment of the present disclosure provides a lottery ticket selling system 100 including: (a) a player electronic device 110 with a courier mobile application downloaded thereon; (b) a courier server 130; (c) a lottery terminal 160; (d) a lottery ticket printer 180; and (e) a central lottery server 200. Various embodiments of the present disclosure are directed to the lottery terminal 160 itself and methods of operation thereof (such as the lottery terminal 160 and method of operation thereof described herein). Various other embodiments of the present disclosure are directed to the lottery terminal 160 and the lottery printer 180 and methods of operation thereof. Various other embodiments of the present disclosure are directed to the lottery terminal 160 and the central lottery server 200 and methods of operation thereof. Various other embodiments of the present disclosure are directed to the central lottery server 200 itself and methods of operation thereof.

In this illustrated example embodiment, the player electronic device 110 and the courier server 130 are configured to communicate with each other via a suitable data network 120 such as but not limited to a cellular data network or the Internet.

In this illustrated example embodiment, the lottery terminal 160 and the lottery ticket printer 180 are configured to communicate with each other via hard wire such as an USB connector. In other embodiments, the communication between these components can be via a suitable data network. In other embodiments, the lottery ticket printer 180 can be built into the same housing as the lottery terminal 160 and thus be physically connected by hard wires.

In this illustrated example embodiment, the lottery terminal 160 and the lottery central system 200 are configured to communicate with each other via a suitable data network 170 such as a cellular data network, the Internet, or a private secure network.

More specifically, the player electronic device 110 with the courier mobile application downloaded thereon can be any suitable device such as an electronic smartphone, an electronic tablet, an electronic watch, or other suitable electronic computing device with suitable data communication, user input, and display functions. The courier mobile application downloaded on the player electronic device 110 can be the exact same commercially available courier mobile application as described above in connection with the fifth example or can be any other suitable courier mobile application. The courier mobile application is configured to enable a player to use the courier mobile application on the player electronic device 110 to set up a player account with the courier service, to deposit funds to the player account, to withdraw funds from the player account, and to use funds in the player account to purchase a lottery ticket for a draw lottery game via the courier mobile application (which can include the player inputting the player's selected numbers or a quick pick request for the draw lottery ticket for the draw lottery game that the player wishes to purchase and thus play). The courier mobile application functions on the player electronic device 110 to generate lottery ticket purchase data (including the player selected numbers or the quick pick numbers) and cause the player electronic device 110 to send the lottery ticket purchase data via the data network 120 to the courier server 130 that is located at a suitable courier processing center (not shown).

The courier server 130 is a suitable server configured to perform at least the various functions described herein. More specifically, the courier server 130 is configured to receive lottery ticket purchase data from the player electronic device 110 via the courier mobile application and to generate a suitable play slip for the draw lottery game based on the lottery ticket purchase data. The play slip includes lottery ticket information, such as the player's selected numbers or the quick pick numbers for the selected play of the selected draw lottery game. Play slip(s) are provided to the lottery terminal 160 for printing of draw lottery tickets, as described below.

In various embodiments, the courier server 130 is configured to generate the play slip as digital play slip image data (such as in the form of a bit map) based on lottery ticket purchase data and sends that digital play slip image data for the draw lottery game to the lottery terminal 160 or a suitable entity associated with the lottery terminal 160.

In various embodiments, the courier server 130 generates the play slip as a physical printed paper play slip using a courier printer (not shown), as described above in connection with the fifth example or can be any other suitable physical paper play slip. That is, a human courier processing clerk takes the physical printed paper play slip for the play of the draw lottery game to an operator of the lottery terminal 160.

In various embodiments, the courier server 130 hosts a web site that enables a player to use their computer (e.g., the player mobile electronic device) to fill out an electronic play slip with the player numbers (selected by the player or randomly selected by the web site) for the draw lottery game. In some embodiments, the courier server 130 sends the electronic play slip to the lottery terminal 160 via a suitable data network (not shown). In other embodiments, the courier server 130 prints a physical printed paper play slip based on the electronic play slip for use by the operator of the lottery terminal 160.

The lottery terminal 160 includes a controller 300. In various embodiments, the controller 300 includes a processor and a memory (not shown). The memory includes instructions that when executed by the processor cause and/or configure the processor to provide functionality as described herein.

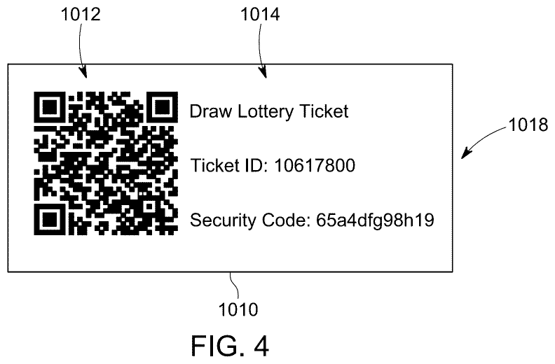

The controller 300 of the lottery terminal 160 is configured to process lottery ticket information for purchase of a draw lottery ticket and to cause printing of that draw lottery ticket in a condensed ticket layout by the lottery ticket printer 180. In various embodiments, the controller 300 is configured to cause the lottery ticket printer 180 to print a physical printed lottery ticket having two or more different ticket layouts, such as the condensed ticket layout of a physical printed lottery ticket 1010 as shown in FIG. 4, an uncondensed ticket layout of the physical draw lottery ticket 10 as shown in FIG. 1, and/or other suitable ticket layouts. In certain such embodiments, the controller 300 selectively causes the lottery ticket printer 180 to print physical printed lottery tickets in the condensed ticket layout and the uncondensed ticket layout. In various embodiments, the lottery terminal 160 is configured to generate a virtual draw lottery ticket having the uncondensed ticket layout, the condensed ticket layout, and/or other suitable ticket layout.

In various embodiments, the lottery ticket information processed by the controller 300 includes: (1) player numbers (or quick pick numbers); (2) a ticket identifier that uniquely identifies a lottery ticket; (3) a game identifier that identifies a lottery game type; (4) a draw date associated with the lottery ticket; (5) a print date on which the lottery ticket is printed or will be printed; (6) ticket security information; (7) other suitable lottery game information; and/or (8) other suitable ticket information. The lottery ticket information can include human readable information (e.g., alphanumeric characters), image data (e.g., logos or other graphics), bar codes, QR codes, and/or other information formats.

In various embodiments, the lottery ticket information is based on a play slip. The play slip can be a physical paper play slip, digital play slip data, and/or an electronic play slip, as described above. In various embodiments, the controller 300 modifies the lottery ticket information to include quick pick numbers, for example, when the play slip includes a quick pick indication. That is, when the play slip includes the quick pick indication, the controller 300 determines quick pick numbers based on the quick pick indication and modifies the lottery ticket information to include the determined quick pick numbers. In various embodiments, the controller 300 modifies the lottery ticket information to include a print date for the lottery ticket or other suitable information. In various embodiments, the lottery terminal 160 communicates with the lottery central system 200 to facilitate the purchase of the draw lottery ticket, select and/or confirm the quick pick numbers, or perform other lottery ticket related functions.

In various embodiments, the lottery terminal 160 includes a lottery ticket vending machine having purchaser interface components (not shown), such as display devices, touch-screen displays, user input devices (e.g., buttons, keypads), code readers (e.g., barcode readers, QR code readers, image capture devices), and/or payment acceptors. The purchaser interface components enable a ticket purchaser and/or operator of the lottery terminal 160 to use such components to input lottery ticket purchase data for selecting and paying for draw lottery tickets that the ticket purchaser desires to obtain. That is, the lottery terminal 160 generates the lottery ticket information for the lottery ticket based on user inputs (e.g., lottery ticket purchase data) from the ticket purchaser and/or operator of the lottery terminal 160 via the purchaser interface components. These purchaser interface components can take many different forms as well known in the industry, and are thus not described in detail herein for brevity.

In the embodiment shown in FIG. 3, the controller 300 includes a ticket printing module 310, a ticket encoding module 320, and a ticket decoding module 330. The ticket printing module 310 is configured to generate ticket printer data including data and/or instructions that cause the ticket printer 180 to print a draw lottery ticket based on the lottery ticket information. In various embodiments, the ticket printer data includes draw lottery ticket encoded data and human readable information, such as the draw lottery ticket encoded data 1012 and the human readable information 1014 described below. In various embodiments, the ticket printer data includes only the draw lottery ticket encoded data and does not include any human readable information.

The ticket encoding module 320 is configured to receive the lottery ticket information (or a portion thereof) and generate draw lottery ticket encoded data (e.g., draw lottery ticket encoded data 1012) that is based on the lottery ticket information. That is, the ticket encoding module 320 encodes the lottery ticket information and outputs the draw lottery ticket encoded data. The ticket decoding module 330 is configured to receive scanned encoded data from a code reader of the lottery terminal 160 and to decode the scanned encoded data, for example, to obtain lottery ticket information that was previously encoded by the ticket encoding module 320 (or other suitable entity). In various embodiments, the lottery terminal 160 includes a module (not shown) that is configured to control the operation of the lottery terminal 160, for example, to facilitate the selection, purchase, and dispensing of each requested draw lottery ticket.

The example lottery ticket printer 180 includes: (a) a printer housing (not shown); (b) a plurality of ticket engagers (not shown) supported by the printer housing; and (c) a controller (not shown). The size and configuration of the lottery ticket printer 180 can vary in accordance with the present disclosure. The example lottery ticket printer 180 is configured to receive the ticket printer data from the lottery terminal 160 and print a physical lottery ticket based on the ticket printer data.

The lottery central system 200 can be any suitable lottery central system. For this illustrated example embodiment, the configuration, and functions of the lottery central system 200 does not need to change from the conventional configuration and functions of a lottery ticket printer, and is thus not described herein for brevity.

Turning to FIG. 4, an example embodiment of a physical printed lottery ticket 1010 having a condensed ticket layout is shown. The physical printed lottery ticket 1010 includes draw lottery ticket encoded data 1012 and human readable information 1014 that are printed on a front surface of a ticket substrate for the physical printed lottery ticket 1010. In various embodiments, a rear surface of the ticket substrate of the physical printed lottery ticket 1010 includes the draw lottery ticket encoded data 1012 (or a portion thereof) and/or the human readable information 1014 (or a portion thereof).

In the embodiment shown in FIG. 4, the draw lottery ticket encoded data 1012 includes a quick response (QR) code format. In other embodiments, the draw lottery ticket encoded data 1012 includes a two dimensional code format, an image format, or other suitable encoded format. As described above, the draw lottery ticket encoded data 1012 is based on lottery ticket information for a draw lottery ticket. In various embodiments, the ticket encoding module 320 encodes all of the lottery ticket information to generate the draw lottery ticket encoded data 1012. In various other embodiments, the ticket encoding module 320 encodes less than all of the lottery ticket information to generate the draw lottery ticket encoded data 1012.

The human readable information 1014 is different from the lottery ticket information. In various embodiments, the human readable information 1014 includes abridged lottery ticket information and includes less than all of the lottery ticket information. That is, at least some of the lottery ticket information is omitted from the human readable information 1014. In various embodiments, the draw lottery ticket encoded data 1012 includes a first portion of the lottery ticket information and the human readable information 1014 includes a second, remainder portion of the lottery ticket information. That is, the draw lottery ticket encoded data 1012 and the human readable information 1014, when taken together, include all of the lottery ticket information. In various embodiments, the draw lottery ticket encoded data 1012 includes lottery ticket information that is also included within the human readable information 1014. For example, both the draw lottery ticket encoded data 1012 and the human readable information 1014 can include the ticket identifier and/or other suitable lottery ticket information.

In various embodiments, the human readable information 1014 is configured to identify the physical printed lottery ticket 1010 as a lottery ticket to a person viewing the physical printed lottery ticket, but does not necessarily indicate to that person whether the physical printed lottery ticket is a winning lottery ticket. That is, In various embodiments, the human readable information 1014 does not include the player numbers, the lottery game information, and/or a draw date associated with the player numbers. In the embodiment shown in FIG. 4, the human readable information 1014 includes alphanumeric characters. In other embodiments, the human readable information 1014 includes other human readable formats, such as symbols, images, etc. In various embodiments, the physical printed lottery ticket 1010 does not include any human readable information. In such embodiments, the draw lottery ticket encoded data 1012 of the lottery ticket is scannable by a suitable code reader to obtain the lottery ticket information, as described herein.

Rather than print each part of the lottery ticket information on a surface of the physical printed lottery ticket using a human readable format, the lottery terminal 160, via the ticket encoding module 320, encodes the lottery ticket information and generates the draw lottery ticket encoded data 1012 to have an encoded format that is not readily human readable. By avoiding a human readable format (e.g., alphanumeric characters with a suitably legible font size for a person), the lottery terminal 160 enables the lottery ticket information to be printed in a smaller overall area as compared to the same lottery ticket information when printed using the human readable format. In other words, by using the condensed ticket layout, the lottery terminal 160 enables a reduction in a physical size of the physical printed lottery ticket and/or quantities of the physical supplies needed to print the physical lottery tickets. In certain scenarios, the lottery terminal 160 enables a reduction in transportation costs and storage costs associated with the physical printed lottery tickets, for example, due to the reduced size and weight for a quantity of the physical printed lottery tickets.

In various embodiments, the lottery terminal 160 enables improved security of the physical printed lottery ticket by displaying at least some of the lottery ticket information in a format that is not readily human readable. In some such embodiments, the lottery terminal 160 causes the player numbers for a draw lottery ticket to be included within the draw lottery ticket encoded data 1012, instead of being included within the human readable information 1014 in plain text. In these embodiments, a person other than the ticket purchaser that views the physical printed lottery ticket 1010 cannot readily read the player numbers and determine whether the physical printed lottery ticket 1010 is a winning ticket, making the physical printed lottery ticket a less likely target for theft.

When a draw lottery ticket having the condensed layout is a winning draw lottery ticket, the ticket can be redeemed for an associated winning amount. In certain embodiments for a physical printed lottery ticket (e.g., the physical printed lottery ticket 1010), the courier service can retrieve and redeem the stored winning physical printed lottery ticket on behalf of the player at a location having a lottery terminal (e.g., the lottery terminal 160), and provide the winning amount to the player. In certain embodiments, such as if the winning amount is $600 or more, a courier processing clerk retrieves the stored winning physical lottery ticket from the courier storage location and sends that physical printed lottery ticket to the player so that the player can redeem that lottery ticket and obtain the winning amount.

In certain embodiments, the lottery terminal 160 includes a code reader configured to scan the draw lottery ticket encoded data 1012. When redeeming a winning draw lottery ticket having the condensed layout, the lottery terminal 160 causes the code reader to scan the draw lottery ticket encoded data 1012 and provide scanned encoded data to the ticket decoding module 330. The ticket decoding module 330 then decodes the scanned encoded data to obtain lottery ticket information that was previously encoded by the ticket encoding module 320. As described above, the lottery ticket information decoded from the draw lottery ticket encoded data 1012 can include the player numbers, the ticket identifier, the game identifier, the draw date, and/or other suitable information. In certain embodiments, the lottery terminal 160 exchanges data based on the lottery ticket information with the lottery central system 200 to enable authentication and redemption of the winning amount for the winning draw lottery ticket.

In various embodiments, multiple draw lottery tickets having the condensed ticket layout are printed on a same ticket substrate. That is, multiple draw lottery tickets are printed on a same page, sheet, or piece of paper. In certain embodiments, when redeeming a winning draw lottery ticket, that winning draw lottery ticket is cut from the ticket substrate and separated from other draw lottery tickets. In some examples, a ticket substrate includes draw lottery tickets for a plurality of different ticket purchasers and a winning draw lottery ticket is cut from the ticket substrate to be provided to one of the ticket purchasers. That is, the ticket purchaser of the winning draw lottery ticket receives the cut ticket, but not the entire ticket substrate and thus does not receive draw lottery tickets for other ticket purchasers. In some examples, the winning draw lottery ticket is cut from the ticket substrate and separated from other draw lottery tickets to reduce an amount of paper that must be carried and presented to redeem the winning draw lottery ticket.

Turning now to FIG. 5, an example method 500 of printing a draw lottery ticket having a condensed ticket layout using the lottery ticket selling system 100 is now described. Although the method is described with reference to the flowchart shown in FIG. 5, other methods of performing the acts associated with this illustrated process may be employed. For example, the order of certain of the illustrated blocks may be changed, certain of the illustrated blocks may be optional, or certain of the illustrated blocks may not be employed.

In this example system and method for printing a draw lottery ticket having a condensed ticket layout, lottery ticket purchase data for purchasing a draw lottery ticket is received, as indicated by block 502. In this example, a player uses the courier mobile application on the player electronic device 110 to select the play of the draw lottery game and the player numbers (or the quick pick numbers) for that play of the draw lottery game. The courier mobile application on the player electronic device 110 creates the lottery ticket purchase data (including the player selected play of the draw lottery game and the player numbers or the quick pick numbers) for that play of the draw lottery game and sends such lottery ticket purchase data to the courier server 130. In other words, the player's mobile electronic device sends the lottery ticket purchase data via the data network 120 (FIG. 2) to the courier server 130. The courier server 130 uses the received lottery ticket purchase data to process the player wager, including deducting the wager amount from the player funds in the player account maintained by the courier service for the player.

In this example, the courier server 130 generates a play slip that includes lottery ticket information using the received lottery ticket purchase data, as indicated by block 504. As described above, the play slip can be a physical paper play slip, digital play slip data, and/or an electronic play slip.

In this example, the courier server 130 sends the lottery ticket information to the lottery terminal 160, as indicated by block 506. For example, the physical paper play slip is provided to an operator of the lottery terminal 160 by a human courier processing clerk, the digital play slip data is sent to the lottery terminal 160, or the electronic play slip is sent to the lottery terminal 160.

In this example, the lottery terminal 160 encodes the lottery ticket information to generate draw lottery ticket encoded data 1012, as indicated by block 508.

In this example, the lottery ticket information includes: (1) player numbers; (2) a ticket identifier that uniquely identifies a lottery ticket; (3) a game identifier that identifies a lottery game type; (4) a draw date associated with the lottery ticket; (5) a print date on which the lottery ticket will be printed; and (6) ticket security information.

In this example, the ticket encoding module 310 generates the draw lottery ticket encoded data 1012 to include: the player numbers; the draw date associated with the lottery ticket; and the print date on which the lottery ticket will be printed. In other words, the draw lottery ticket encoded data 1012 does not include the ticket identifier, the game identifier, and the ticket security information.

In this example, the lottery terminal 160 generates ticket printer data in the condensed ticket layout based on the lottery ticket information, as indicated by block 510. That is, the ticket printing module 310 generates the ticket printer data to include the draw lottery ticket encoded data 1012 and the human readable information 1014. In this example, the ticket printing module 310 generates the human readable information 1014 to include the ticket identifier, the game identifier, and the ticket security information.

In this example, the lottery terminal 160 causes the lottery ticket printer 180 to print the physical printed lottery ticket in the condensed ticket layout using the ticket printer data, as indicated by block 512. That is, the lottery terminal 160 sends the ticket printer data to the lottery ticket printer 180 to cause printing of the physical printed lottery ticket 1010.

In various embodiments, the method 500 described above also includes scanning the draw lottery ticket encoded data 1012 of the physical printed lottery ticket to obtain scanned encoded data and then decoding the scanned encoded data to generate the lottery ticket information. For example, the lottery terminal 160 or another suitable entity uses a code reader to scan the draw lottery ticket encoded data 1012 and generate scanned encoded data. In this example, the ticket decoding module 330 decodes the scanned encoded data to generate the lottery ticket information that was previously encoded by the ticket encoding module 320. That is, the ticket decoding module 330 decodes the scanned encoded data to generate the player numbers, the draw date associated with the lottery ticket, and the print date associated with the lottery ticket. In various embodiments, the lottery terminal 160 scans the draw lottery ticket encoded data 1012 of the physical printed lottery ticket for redemption of that lottery ticket. In various embodiments, the lottery terminal 160 scans the draw lottery ticket encoded data 1012 to facilitate re-purchasing the same player numbers on a new lottery ticket. That is, the lottery terminal 160 uses the lottery ticket information as lottery ticket purchase data for the new lottery ticket.

In various embodiments, the lottery terminal 160 stores the lottery ticket information, determines a link (e.g., a universal resource locator, URL) to the stored lottery ticket information, and encodes the link as the draw lottery ticket encoded data 1012. In an example embodiment, decoding of the draw lottery ticket encoded data 1012 generates the link instead of the lottery ticket information itself. The link can then be followed to obtain the stored lottery ticket information. In this example embodiment, the lottery terminal 160 enables improved security of the physical printed lottery ticket 1010 by generating and encoding the link because any attempt at redemption of the printed physical lottery ticket 1010, or even viewing of the player numbers, would require visiting the link over an Internet connection. Visiting the link can be associated with generating a digital forensic trail indicating a particular user device that visited the link, such as an IP address of a smartphone or computer. In some scenarios, a lost or stolen physical printed lottery ticket can be recovered using the digital forensic trail, for example, by contacting an owner of the IP address. In some embodiments, the lottery terminal 160 is configured to block access to a link to lottery ticket information based on an IP address of the accessing user device, for example, to prevent access from jurisdictions that do not allow draw lottery games.

In the example embodiment of the physical printed lottery ticket 1010 having the condensed ticket layout shown in FIG. 4, the physical printed lottery ticket 1010 includes one section of draw lottery ticket encoded data and one section of human readable information. In other embodiments, the lottery terminal 160 generates ticket printer data in a condensed ticket layout having multiple sections of draw lottery ticket encoded data. In various embodiments, the multiple sections of draw lottery ticket encoded data include different lottery ticket information. As one such example embodiment, a first section includes player numbers and a draw date and a second section includes ticket security information. As another example embodiment, a first section includes player numbers and a draw date for a first draw date, a second section includes player numbers and a draw date for a second, different draw date.

In various embodiments, at least some of the multiple sections of draw lottery ticket encoded data include same lottery ticket information. In one such example embodiment, a first section includes player numbers and a draw date and a second section includes the draw date and the game identifier.

In various embodiments, the lottery terminal 160 selectively prints the physical printed lottery tickets to have the condensed ticket layout or other, different ticket layouts. That is, for a purchased draw lottery ticket, the controller 300 determines a ticket layout from among a plurality of ticket layouts. In various embodiments, the controller 300 determines whether to print the physical printed lottery ticket 1010 as seen in FIG. 4 or the physical printed lottery ticket 10 as seen in FIG. 1. In various embodiments, the controller 300 causes purchaser interface components of the lottery terminal 160 to prompt a purchaser for a user selection of the ticket layout. In various other embodiments, the controller 300 automatically selects the condensed ticket layout responsive to an occurrence of a condensed ticket layout condition. In various embodiments, the controller 300 determines that the condensed ticket layout condition has occurred when a ticket purchaser has purchased: (1) player numbers for multiple plays of a draw lottery game within a same transaction; (2) multiple sets of player numbers for a single play of a draw lottery game within a same transaction; (3) multiple sets of player numbers for multiple plays of the draw lottery game within a same transaction; and/or (4) multiple draw lottery tickets for multiple, different draw lottery games within a same transaction.

In various embodiments, the draw lottery ticket encoded data 1012 includes compressed data. That is, the ticket encoding module 320 performs one or more lossless data compression techniques to compress the lottery ticket information (or a portion thereof) before encoding. As an example for a draw lottery ticket that includes multiple sets of player numbers for a single play of a draw lottery game, the ticket encoding module 320 compresses the multiple sets of player numbers into compressed player number data and then encodes the compressed player number data. In such examples, the draw lottery ticket encoded data 1012 is smaller than the draw lottery ticket encoded data 1012 when used without compression.

In various embodiments, the draw lottery ticket encoded data 1012 includes encrypted data. That is, the ticket encoding module 320 performs one or more cryptographic functions to encrypt the lottery ticket information (or a portion thereof) before encoding. As one example, the ticket encoding module 320 encrypts the player numbers into encrypted player number data and then encodes the encrypted player number data. In such examples, even if a person that does not rightfully own the physical printed lottery ticket 1010 obtains the lottery ticket and decodes the draw lottery ticket encoded data 1012, that person cannot readily determine the player numbers and determine whether the lottery ticket is a winning ticket, making the physical printed lottery ticket a less likely target for theft.

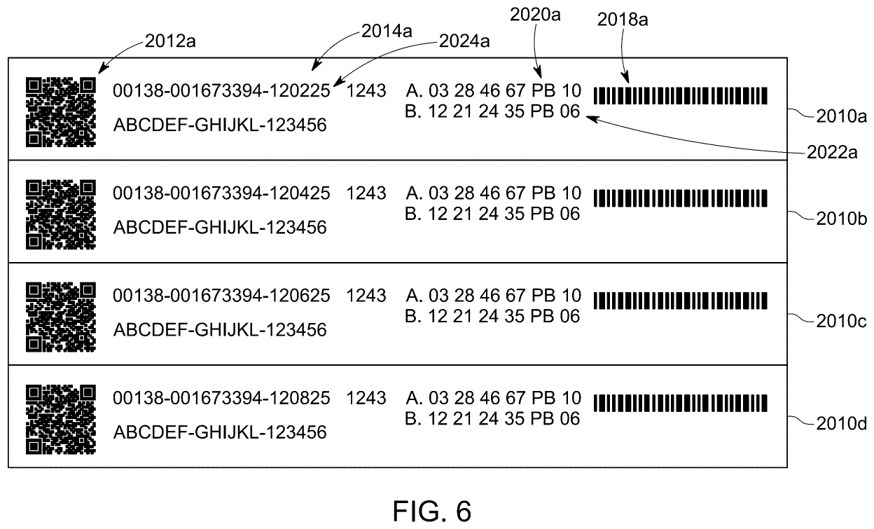

Turning to FIG. 6, a plurality of draw lottery tickets printed in a condensed ticket layout in accordance with an alternative embodiment of the present disclosure are shown. The plurality of draw lottery tickets includes physical printed lottery tickets 2010a, 2010b, 2010c, and 2010d that are printed on a same ticket substrate (e.g., a page, sheet, or piece of paper). As described above, a winning draw lottery ticket can be cut and separated from the other draw lottery tickets printed on the ticket substrate. The plurality of draw lottery tickets have the same condensed ticket layout, so only the physical printed lottery ticket 2010a is described for brevity. In this example, lottery ticket information associated with the physical printed lottery ticket 2010a includes: (1) a first set of player numbers; (2) a second set of player numbers; (3) a game identifier that identifies a lottery game type; (4) a draw date associated with the lottery ticket; (5) a ticket identifier that uniquely identifies the lottery ticket; and (6) ticket security information.

In this example embodiment, the physical printed lottery ticket 2010a includes first draw lottery ticket encoded data 2012a, human readable information 2014a, and second draw lottery ticket encoded data 2018a. The first draw lottery ticket encoded data 2012a includes: the first set of player numbers; the second set of player numbers; the game identifier that identifies the lottery game type; and the draw date associated with the lottery ticket. The human readable information 2014a includes: the first set of player numbers shown as 2020a; the second set of player numbers shown as 2022a; and the draw date shown as 2024a. The second draw lottery ticket encoded data 2018a includes the ticket identifier, shown as a bar code.

In this example embodiment, both the first draw lottery ticket encoded data 2012a and the human readable information 2014a include the first set of player numbers, the second set of player numbers, and the draw date.

In the example shown in FIG. 6, the plurality of draw lottery tickets have a same layout. In other embodiments, two or more of the plurality of draw lottery tickets have different condensed ticket layouts.

In various embodiments, the lottery terminal 160 includes a virtual ticket generator (not shown) that generates a virtual lottery ticket in addition to the printed physical lottery ticket 1010 in the condensed ticket layout. The virtual lottery ticket can be provided to a ticket purchaser in an electronic format (e.g., an image format) via the player electronic device 110. In various embodiments, the virtual lottery ticket includes a ticket layout that is the same as the printed physical lottery ticket. That is, the virtual lottery ticket has a condensed ticket layout and appears, when viewed on a display device, as shown in FIG. 4.

In various embodiments, the lottery terminal 160 generates the virtual lottery ticket to include a ticket layout that is different from the printed physical lottery ticket 1010. In certain such embodiments, the lottery terminal 160 generates the virtual lottery ticket with a different condensed ticket layout. In some such embodiments, the virtual lottery ticket includes more lottery ticket information within the human readable information 1014 than the printed physical lottery ticket 1010. For example, the virtual lottery ticket can include player information and/or ticket ownership information. In other such embodiments, the virtual lottery ticket includes less lottery ticket information within the human readable information 1014 than the printed physical lottery ticket 1010. For example, the virtual lottery ticket can omit ticket security information.

In various other embodiments, the lottery terminal 160 generates the virtual lottery ticket with the uncondensed ticket layout of the lottery ticket 10 as shown in FIG. 1. In this example embodiment, the ticket purchaser can use the virtual lottery ticket in the uncondensed ticket layout to more easily identify whether their player numbers are winning player numbers for the associated play of the draw lottery game.

It should be appreciated that various embodiments of the present disclosure provide more space on a draw lottery ticket for other information and/or displays such as but not limited to marketing information and/or displays, player messaging, graphical content, all while the size of the draw lottery ticket is minimized.

It should be appreciated from the above that various embodiments of the present disclosure provide a lottery ticket terminal including a lottery ticket printer and configured to: (1) receive lottery ticket information for a purchased draw lottery ticket; (2) encode the lottery ticket information to generate draw lottery ticket encoded data for the purchased draw lottery ticket; (3) generate human readable information based on the lottery ticket information; (4) generate ticket printer data associated with a condensed ticket layout that comprises the draw lottery ticket encoded data and the human readable information; and (5) cause the lottery ticket printer to print a physical printed lottery ticket in the condensed ticket layout for the purchased draw lottery ticket using the ticket printer data. In various such embodiments, the human readable information is different from the lottery ticket information. In various such embodiments, the human readable information comprises less than all of the lottery ticket information. In various such embodiments, the lottery ticket information comprises player numbers for the purchased draw lottery ticket, wherein the human readable information excludes the player numbers, and wherein the draw lottery ticket encoded data is decodable to obtain the player numbers. In various such embodiments, (1) the lottery ticket information comprises: a ticket identifier associated with the purchased draw lottery ticket, an identifier of a draw lottery game associated with the purchased draw lottery ticket, a draw date associated with the draw lottery game, and player numbers associated with the purchased draw lottery ticket; (2) the human readable information comprises: the ticket identifier associated with the purchased draw lottery ticket, and the identifier of the draw lottery game associated with the purchased draw lottery ticket, and excludes the player numbers associated with the purchased draw lottery ticket; and (3) the lottery ticket terminal is configured to: (a) generate full human readable information based on the lottery ticket information, the full human readable information comprising all of the lottery ticket information; (b) generate full ticket printer data associated with a normal ticket layout that comprises the full human readable information; and (c) cause the lottery ticket printer to print a physical printed lottery ticket in the condensed ticket layout for the purchased draw lottery ticket using the full ticket printer data. In various such embodiments, the lottery ticket terminal comprises a code scanner, and is configured to scan the draw lottery ticket encoded data and generate scanned encoded data, and decode the scanned encoded data to generate the lottery ticket information. In various such embodiments, the draw lottery ticket encoded data includes less than all of the lottery ticket information. In various such embodiments, the lottery ticket terminal is configured to modify the lottery ticket information to include player numbers when the lottery ticket information comprises a quick pick indication. In various such embodiments, the lottery ticket terminal comprises purchaser interface components. In various such embodiments, the lottery ticket terminal is configured to cause the lottery ticket printer to print each of a plurality of draw lottery tickets in the condensed ticket layout.

It should be further appreciated from the above that various embodiments of the present disclosure provide a lottery ticket terminal including a lottery ticket printer and configured to: (1) receive lottery ticket information for a purchased draw lottery ticket; (2) determine a ticket layout for the purchased draw lottery ticket from among a plurality of different ticket layouts; and (3) responsive to the determined ticket layout being a condensed ticket layout: (i) encode the lottery ticket information to generate draw lottery ticket encoded data for the purchased draw lottery ticket; (ii) generate human readable information based on the lottery ticket information; (iii) generate ticket printer data associated with a condensed ticket layout that comprises the draw lottery ticket encoded data and the human readable information; and (iv) cause the lottery ticket printer to print a physical printed lottery ticket in the condensed ticket layout for the purchased draw lottery ticket using the ticket printer data.

It should be further appreciated from the above that various embodiments of the present disclosure provide a lottery ticket terminal including a lottery ticket printer and configured to: (1) print on paper each of a plurality of draw lottery tickets in a first layout; and (2) print on paper each of the plurality of draw lottery tickets in a second condensed layout, wherein the second condensed layout is different than the first layout, wherein in the second condensed layout each printed draw lottery ticket is printed on a lesser amount of the paper than if printed in the first layout. In various such embodiments, the second condensed layout comprises human readable information. In various such embodiments, the second condensed layout does not comprise human readable information. In various such embodiments, the second condensed layout comprises draw lottery ticket player numbers. In various such embodiments, the second condensed layout does not comprise draw lottery ticket player numbers. In various such embodiments, the second condensed layout comprises a draw lottery game identification. In various such embodiments, the second condensed layout comprises a draw lottery game date indication. In various such embodiments, the second condensed layout comprises a QR code and no bar codes. In various such embodiments, the second condensed layout comprises draw lottery ticket player numbers, a draw lottery game identification a draw lottery game date indication, and a QR code.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket terminal comprising:
a lottery ticket printer;
a processor; and
a memory device that stores a plurality of instructions, which when executed by the processor cause the processor to:
receive lottery ticket information for a purchased draw lottery ticket;
encode the lottery ticket information to generate draw lottery ticket encoded data for the purchased draw lottery ticket;
generate human readable information based on the lottery ticket information;
generate ticket printer data associated with a condensed ticket layout that comprises the draw lottery ticket encoded data and the human readable information; and
cause the lottery ticket printer to print a physical printed lottery ticket in the condensed ticket layout for the purchased draw lottery ticket using the ticket printer data.

2. The lottery ticket terminal of claim 1, wherein the human readable information is different from the lottery ticket information.

3. The lottery ticket terminal of claim 2, wherein the human readable information comprises less than all of the lottery ticket information.

4. The lottery ticket terminal of claim 3, wherein the lottery ticket information comprises player numbers for the purchased draw lottery ticket, wherein the human readable information excludes the player numbers, and wherein the draw lottery ticket encoded data is decodable to obtain the player numbers.

5. The lottery ticket terminal of claim 1, wherein:
the lottery ticket information comprises: a ticket identifier associated with the purchased draw lottery ticket, an identifier of a draw lottery game associated with the purchased draw lottery ticket, a draw date associated with the draw lottery game, and player numbers associated with the purchased draw lottery ticket;
the human readable information comprises: the ticket identifier associated with the purchased draw lottery ticket, and the identifier of the draw lottery game associated with the purchased draw lottery ticket, and excludes the player numbers associated with the purchased draw lottery ticket; and
the plurality of instructions, when executed by the processor, cause the processor to:
generate full human readable information based on the lottery ticket information, the full human readable information comprising all of the lottery ticket information;
generate full ticket printer data associated with a normal ticket layout that comprises the full human readable information; and
cause the lottery ticket printer to print a physical printed lottery ticket in the condensed ticket layout for the purchased draw lottery ticket using the full ticket printer data.

6. The lottery ticket terminal of claim 1, which comprises a code scanner, and wherein the plurality of instructions, when executed by the processor, cause the processor to scan the draw lottery ticket encoded data and generate scanned encoded data, and decode the scanned encoded data to generate the lottery ticket information.

7. The lottery ticket terminal of claim 1, wherein the draw lottery ticket encoded data includes less than all of the lottery ticket information.

8. The lottery ticket terminal of claim 1, wherein the plurality of instructions, when executed by the processor, cause the processor to modify the lottery ticket information to include player numbers when the lottery ticket information comprises a quick pick indication.

9. The lottery ticket terminal of claim 1, which comprises purchaser interface components.

10. The lottery ticket terminal of claim 1, wherein the plurality of instructions, when executed by the processor cause the processor to cause the lottery ticket printer to print each of a plurality of draw lottery tickets in the condensed ticket layout.

11. A lottery ticket terminal comprising:
a lottery ticket printer;
a processor; and
a memory device that stores a plurality of instructions, which when executed by the processor cause the processor to:
receive lottery ticket information for a purchased draw lottery ticket;
determine a ticket layout for the purchased draw lottery ticket from among a plurality of different ticket layouts;
responsive to the determined ticket layout being a condensed ticket layout:
encode the lottery ticket information to generate draw lottery ticket encoded data for the purchased draw lottery ticket;
generate human readable information based on the lottery ticket information;
generate ticket printer data associated with a condensed ticket layout that comprises the draw lottery ticket encoded data and the human readable information; and
cause the lottery ticket printer to print a physical printed lottery ticket in the condensed ticket layout for the purchased draw lottery ticket using the ticket printer data.

12. A lottery ticket terminal comprising:
a lottery ticket printer;
a processor; and
a memory device that stores a plurality of instructions, which when executed by the processor cause the processor to cause the lottery ticket printer to:
print on paper each of a plurality of draw lottery tickets in a first layout; and
print on paper each of the plurality of draw lottery tickets in a second condensed layout, wherein the second condensed layout is different than the first layout, wherein in the second condensed layout each printed draw lottery ticket is printed on a lesser amount of the paper than if printed in the first layout.

13. The lottery ticket terminal of claim 12, wherein the second condensed layout comprises human readable information.

14. The lottery ticket terminal of claim 12, wherein the second condensed layout does not comprise human readable information.

15. The lottery ticket terminal of claim 12, wherein the second condensed layout comprises draw lottery ticket player numbers.

16. The lottery ticket terminal of claim 12, wherein the second condensed layout does not comprise draw lottery ticket player numbers.

17. The lottery ticket terminal of claim 12, wherein the second condensed layout comprises a draw lottery game identification.

18. The lottery ticket terminal of claim 12, wherein the second condensed layout comprises a draw lottery game date indication.

19. The lottery ticket terminal of claim 12, wherein the second condensed layout comprises a QR code and no bar codes.

20. The lottery ticket terminal of claim 12, wherein the second condensed layout comprises draw lottery ticket player numbers, a draw lottery game identification a draw lottery game date indication, and a QR code.
